(19) United States
(12) Patent Application Publication
(10) Pub. No.: US 2006/0172829 A1
(43) Pub. Date: Aug. 3, 2006

(54) Method of controlling continuously variable transmission and control system

(75) Inventor: Masato Ishio, Hyogo (JP)

Correspondence Address: OLIFF & BERRIDGE, PLC, P.O. BOX 19928, ALEXANDRIA, VA, 22320, US

(73) Assignee: Fujitsu Ten Limited, Kobe-shi (JP)

(21) Appl. No.: 11/322,479

(22) Filed: Jan. 3, 2006

(30) Foreign Application Priority Data
Jan. 18, 2005 (JP) 2005-009723

(51) Int. Cl. F16H 61/00; F16H 59/00

(52) U.S. Cl. 474/18; 474/28

(57) ABSTRACT

An oil pressure-learning method which enables an oil pressure control system that controls line pressure and belt clamping pressure by oil pressure actuators independently of each other, to accurately control both the line pressure and the belt clamping pressure. The oil pressure-learning method is applied to an oil pressure control system provided with a line pressure control solenoid for controlling a line pressure control valve, and a belt clamping pressure control solenoid for controlling a belt clamping pressure control valve. A belt clamping pressure command value that is outputted to the belt clamping pressure control solenoid as a control command value of belt clamping pressure, and a line pressure command value that is outputted to the line pressure control solenoid as a control command value of line pressure are learned in advance. This enables the oil pressure control system to control both the line pressure and the belt clamping pressure with accuracy.

### CROSS-REFERENCE TO RELATED APPLICATIONS

This application is based on, and claims priority to, Japanese Application No. 2005-009723, filed Jan. 18, 2005, in Japan, and which is incorporated herein by reference.

### BACKGROUND OF THE INVENTION

1. Field of the Invention

This invention relates to an oil pressure control method and an oil pressure control system, for a continuously variable transmission, and more particularly to an oil pressure control method and an oil pressure control system which are capable of controlling belt clamping pressure and line pressure as source pressure of the belt clamping pressure, of a belt-type continuously variable transmission, independently of each other.

2. Description of the Related Art

Conventionally, a continuously variable transmission (also referred to as a “CVT”) is widely employed as an automatic transmission for automotive vehicles and the like, due to excellent robustness thereof. A belt-type continuously variable transmission as one type thereof has a V belt stretched between a driving pulley (hereinafter referred to as “the primary pulley”) disposed on the engine side and a driven pulley (hereinafter referred to as “the secondary pulley”) disposed on the wheel side. The primary pulley and the secondary pulley are configured such that groove widths thereof can be changed e.g. by oil pressure control. The belt-winding diameter of the primary pulley for winding the V belt therearound is changed by controlling the groove width of the primary pulley, and the groove width of the secondary pulley is changed in accordance with the change in the belt-winding diameter of the primary pulley while holding the belt clamping force of the secondary pulley, whereby the transmission ratio of the continuously variable transmission is continuously changed.

In the continuously variable transmission configured as above, the groove width of the primary pulley is normally controlled by driving the oil pressure control system so as to supply and discharge hydraulic oil to and from a chamber formed between a fixed wheel and a movable wheel which form the primary pulley. Formed between the fixed wheel and the movable wheel is a tapered groove whose groove width is adjusted by causing the movable wheel to move toward and away from the fixed wheel through control of the amount of oil in the chamber. The primary pulley is provided with an oil pressure valve for adjusting the amount of hydraulic oil supplied to and discharged from the chamber, and the oil pressure valve is actuated by an oil pressure actuator implemented e.g. by a solenoid valve. The line pressure generated by pumping hydraulic oil from an oil pressure source is normally supplied to the oil pressure valve.

On the other hand, the belt clamping force of the secondary pulley (hereinafter referred to as “the belt clamping pressure”) is similarly controlled by driving the oil pressure control system to supply and discharge hydraulic oil to and from a chamber formed between a fixed wheel and a movable wheel which form the secondary pulley. The belt clamping pressure is generated by reducing the line pressure, which is supplied as source pressure, by the oil pressure control system. Hydraulic oil at the belt clamping pressure is supplied to the chamber, whereby an appropriate clamping force is applied to the V belt held between the fixed wheel and the movable wheel, which prevents slippage of the V belt.

As described above, although the line pressure is used as source pressure for supplying oil pressure to the oil pressure valves controlled by the respective oil pressure actuators of the oil pressure control system, normally the line pressure is adjusted to pressure dependent on the engine torque. Although in former times, a mechanism was provided which mechanically adjusts line pressure according to the opening degree of a throttle valve, recently, to control oil pressure more optimally, a dedicated oil pressure actuator for adjusting line pressure is provided and an electronic control unit controls the line pressure.

By the way, conventionally, an oil pressure control system has been manufactured which controls the above-mentioned line pressure and belt clamping pressure in an interlocked manner by a common oil pressure actuator (see e.g. Japanese Unexamined Patent Publication No. 11-182662).

FIG. 10 is an explanatory view schematically showing the arrangement of the conventional oil pressure control system of the above-mentioned type, and peripheral component parts associated therewith. Further, FIGS. 11(A) and 11(B) are explanatory views showing states of oil pressure control by the oil pressure control system that controls line pressure and belt clamping pressure using the common oil pressure actuator. FIG. 11(A) shows the relationship between the value of electric current supplied to the oil pressure actuator and control oil pressure generated by the electric current. In FIG. 11(A), the horizontal axis represents the value of electric current supplied to a linear solenoid as an oil pressure actuator, while the vertical axis represents the magnitudes of line pressure and belt clamping pressure. Further, FIG. 11(B) shows the relationship between the transmission ratio of the continuously variable transmission and control oil pressure. In FIG. 11(B), the horizontal axis represents the transmission ratio, while the vertical axis represents the line pressure, the belt clamping pressure, and pressure required by the primary pulley (hereinafter referred to as “the primary pressure”)

Referring to FIG. 10, in the conventional oil pressure control system for the continuously variable transmission, a line pressure control valve 101 for controlling line pressure PL, and a belt clamping pressure control valve 102 for controlling belt clamping pressure POUT are controlled in an interlocked manner by a common oil pressure solenoid 103.

An electronic control unit 104 delivers a control command value calculated based on the difference between a target transmission ratio and an actual transmission ratio to the oil pressure solenoid 103, and by driving the oil pressure solenoid 103, the operation of the line pressure control valve 101 and that of the belt clamping pressure control valve 102 are controlled.

As described above, when the line pressure and the belt clamping pressure are controlled in an interlocked manner by the common oil pressure actuator, as shown in FIG. 11(A), the line pressure PL and the belt clamping pressure POUT are almost proportionally changed. On the other hand, as shown in FIG. 11(B), the belt clamping pressure POUT and the primary pressure PIN are in an inversely proportional relationship. Therefore, to secure the belt clamping pressure POUT in a proportional relationship to the line pressure PL while ensuring the primary pressure PIN at a minimum transmission ratio γmin, the line pressure PL is required to be changed such that it increases in proportion to the belt clamping pressure POUT from a base point of pressure in the vicinity of the primary pressure PIN at the minimum transmission ratio γ min, as shown in FIGS. 11(A) and 11(B). Although the line pressure PL is essentially high enough if it has a magnitude satisfying the higher one of the belt clamping pressure POUT and the primary pressure PIN, it is set to an unnecessarily high value, as shown in the FIGS. 11(A) and 11(B). This results in degradation of energy efficiency and fuel economy.

To cope with the above problems, recently, oil pressure control systems capable of controlling line pressure and belt clamping pressure independently of each other are increasing in number, and becoming mainstream. FIG. 12 is an explanatory view showing a state of oil pressure control by an oil pressure control system that controls line pressure and belt clamping pressure independently of each other, using separate oil pressure actuators, which corresponds to FIG. 11(B).

As shown in FIG. 12, the line pressure PL and the belt clamping pressure POUT are controlled independently of each other, and therefore it is possible to set the line pressure PL to a minimum required value. More specifically, by reducing the magnitude of the line pressure PL to such a level high enough to meet the higher one of the belt clamping pressure POUT and the primary pressure PIN, the line pressure PL can be lowered compared with the above-described conventional control by an amount represented by a hatched portion in FIG. 12. In short, by controlling the line pressure PL and the belt clamping pressure POUT independently of each other, it is possible to avoid an unnecessary increase in the line pressure PL and thereby enhance energy efficiency, whereby fuel economy can be improved.

In this case, it is necessary to provide separate actuators for the line pressure control and the belt clamping pressure control, respectively, which leads to an increase in the cost. However, the enhancement of fuel economy contributes to an increase the commercial value of an automotive vehicle on which the oil pressure control system is installed, and a decrease in the costs of component parts of the whole vehicle is attained. Therefore, it is possible to obtain more advantageous effects than the cost cancellation.

In the above-mentioned oil pressure control system for the continuously variable transmission, it is necessary to accurately control oil pressure for use in control of the continuously variable transmission over the entire oil pressure range. More specifically, for example, structures, such as the springs, spools, and orifices of oil pressure valves, which form the oil pressure control system, have variations in size, shape, and so forth, generated during manufacturing thereof. Also, when a solenoid valve, such as a linear solenoid, is used as an actuator for actuating the oil pressure valve, the solenoid value has variations in electric characteristic. If the control amount of the oil pressure actuator is set, based on theoretical design values, without considering these variations, it is impossible to assure the accuracy of the oil pressure control.

Therefore, to control the oil pressure for use in controlling the continuously variable transmission over the entire oil pressure range with accuracy, a method of learning oil pressure has been proposed, which, however, is for the oil pressure control system for controlling line pressure and belt clamping pressure by a common oil pressure actuator (see e.g. Japanese Unexamined Patent Publication No. 2001-330117).

In this learning method, the current belt clamping pressure (hereinafter referred to as “the actual belt clamping pressure”) POUT(real) is measured by an oil pressure sensor disposed in a chamber of the secondary pulley. Learning correction of a belt clamping pressure command value POUT(tgt) is executed in advance to enable the control to be executed in a feedforward manner such that the difference between the belt clamping pressure command value POUT(tgt) outputted by an electronic control unit and the actual belt clamping pressure POUT(real) is reduced to zero.

According to the above learning method, even if the springs, spools, and orifices of the oil pressure valves for controlling belt clamping pressure have variations in size, shape, and so forth, generated during manufacturing thereof, or even if a solenoid valve for actuating the oil pressure valve has variations in electric characteristic, it is possible to eliminate degradation of oil pressure control accuracy of a belt clamping pressure control section to thereby control the oil pressure over the entire oil pressure range with accuracy. As a result, the control accuracy of the line pressure is enhanced, and the electronic control unit can accurately estimate the line pressure and the belt clamping pressure based on an output value of the linear solenoid and a measured value of the belt clamping pressure by the oil pressure sensor.

However, the above learning method is assumed to be applied to the oil pressure control system that controls the oil pressure valve for generating line pressure and the oil pressure valve for generating belt clamping pressure by the common oil pressure actuator. Therefore, if the learning method is applied to a recent oil pressure control system that controls line pressure and belt clamping pressure by separate oil pressure actuators independently of each other, the control accuracy of the belt clamping pressure is enhanced but that of the line pressure is not, since learning correction of the line pressure is not executed. The line pressure serves as source pressure also for oil pressures for use in controlling devices other than the oil pressure control system of the continuously variable transmission, such as transmission control and clutch control, and hence to accurately control the devices and the continuously variable transmission, it is necessary to control the line pressure with accuracy. Further, the electronic control unit as well is required to accurately calculate and predict the actual line pressure.

### SUMMARY OF THE INVENTION

The present invention has been made in view of these problems, and an object thereof is to enable an oil pressure control system that controls line pressure and belt clamping pressure by separate oil pressure actuators independently of each other to accurately control both line pressure and belt clamping pressure.

To attain the above object, there is provided a method of controlling a continuously variable transmission that generates belt clamping pressure supplied to a secondary pulley from line pressure generated by controlling oil pressure of an oil pressure source. The control method comprises: a belt clamping pressure-learning step of performing learning correction of a belt clamping pressure command value based on the belt clamping pressure command value and an actual belt clamping pressure value; and a line pressure-learning step of performing learning correction of a line pressure command value based on the line pressure command value and an actual line pressure value.

Further, to attain the above object, there is provided a control system for a continuously variable transmission. The control system comprises: a line pressure command value-calculating section that calculates a line pressure command value for controlling a valve that is used for generating line pressure from oil pressure of an oil pressure source; a belt clamping pressure command value-calculating section that calculates a belt clamping pressure command value for controlling a valve that is used for generating belt clamping pressure supplied to a secondary pulley, from the line pressure; a belt clamping pressure correction value-calculating section that performs learning correction of the belt clamping pressure command value based on the belt clamping pressure command value and an actual belt clamping pressure value; and a line pressure correction value-calculating section that performs learning correction of the line pressure command value based on the line pressure command value and an actual line pressure value.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram showing a system configuration of a vehicle control system including a continuously variable transmission.

FIG. 2 is an explanatory view schematically showing the arrangement of the continuously variable transmission.

FIG. 3 is an explanatory view schematically showing the arrangement of essential components of the continuously variable transmission to which an oil pressure-learning method is applied.

FIG. 4 is a functional block diagram illustrating an example of an oil pressure learning process executed by a CVTECU.

FIG. 5 is a timing diagram showing an example of the oil pressure learning process executed by the CVTECU.

FIG. 6 is an explanatory view showing an example of influence of hysteresis in oil pressure control using a solenoid-actuated control valve.

FIGS. 7(A) and 7(B) are explanatory views showing timings for measuring actual belt clamping pressure at respective stages of learning correction.

FIG. 8 is a conceptual diagram showing results of the learning correction.

FIG. 9 is a flowchart showing a flow of the oil pressure learning process carried out by the CVTECU.

FIG. 10 is an explanatory view schematically showing the arrangement of a conventional oil pressure control system and peripheral component parts associated therewith.

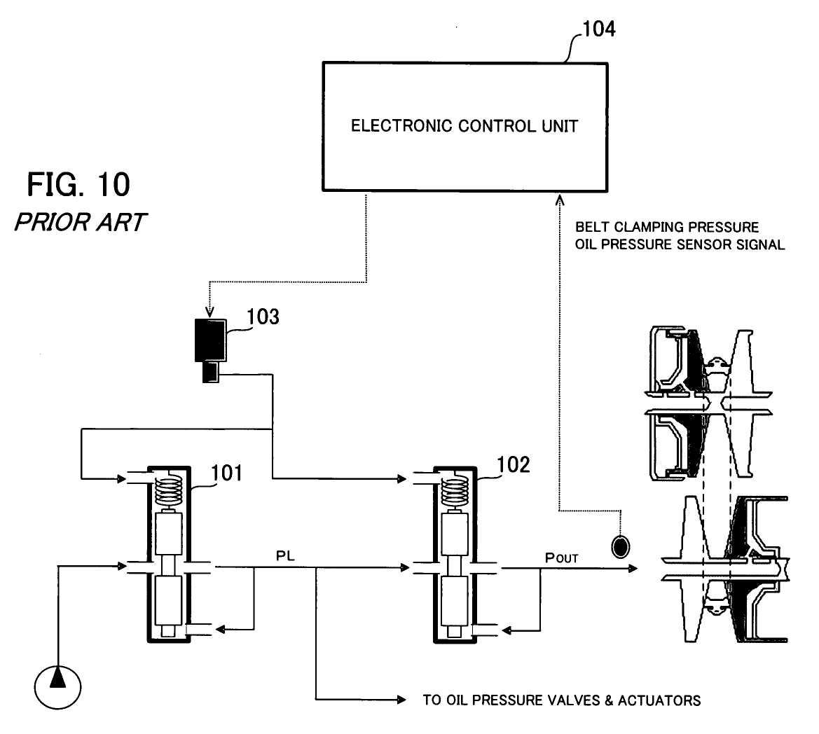

FIGS. 11(A) and (B) are explanatory views showing states of oil pressure control by an oil pressure control system that controls line pressure and belt clamping pressure using a common oil pressure actuator.

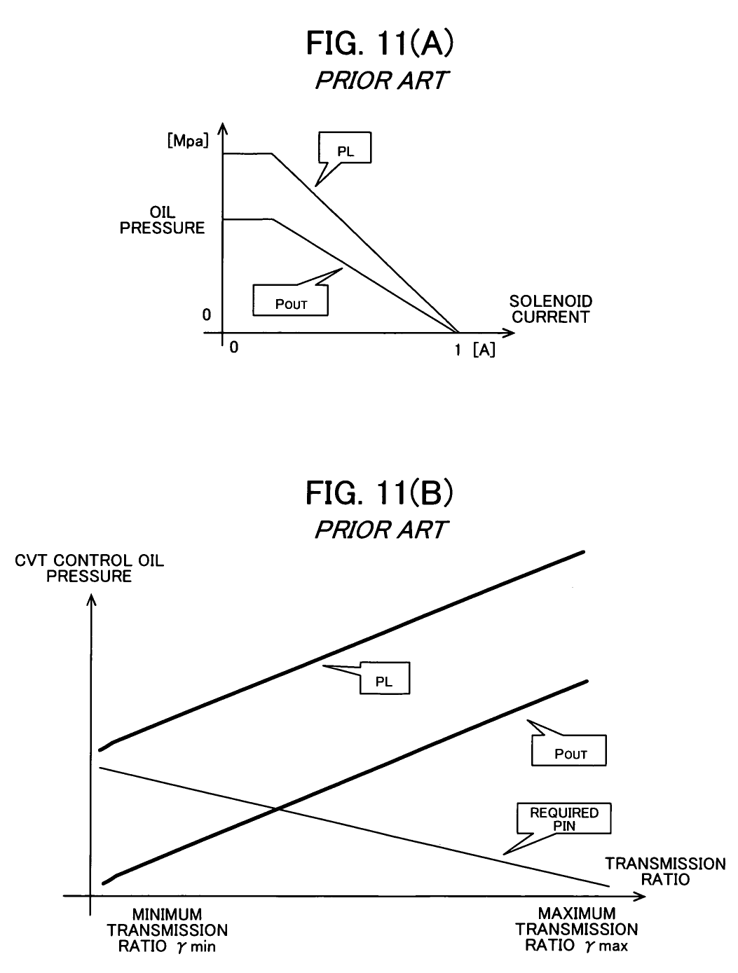

FIG. 12 is an explanatory view showing a state of oil pressure control by an oil pressure control system that controls line pressure and belt clamping pressure independently of each other using oil pressure actuators separate from each other.

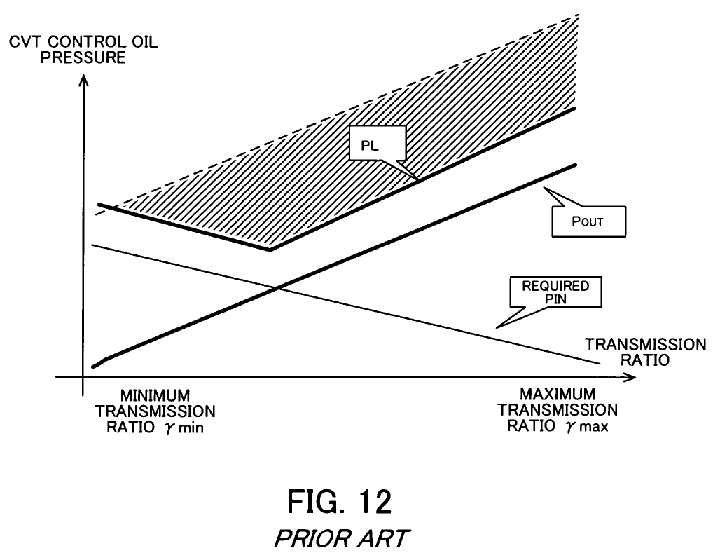

### DESCRIPTION OF THE PREFERRED EMBODIMENTS

The invention will now be described in detail with reference to drawings showing a preferred embodiment thereof.

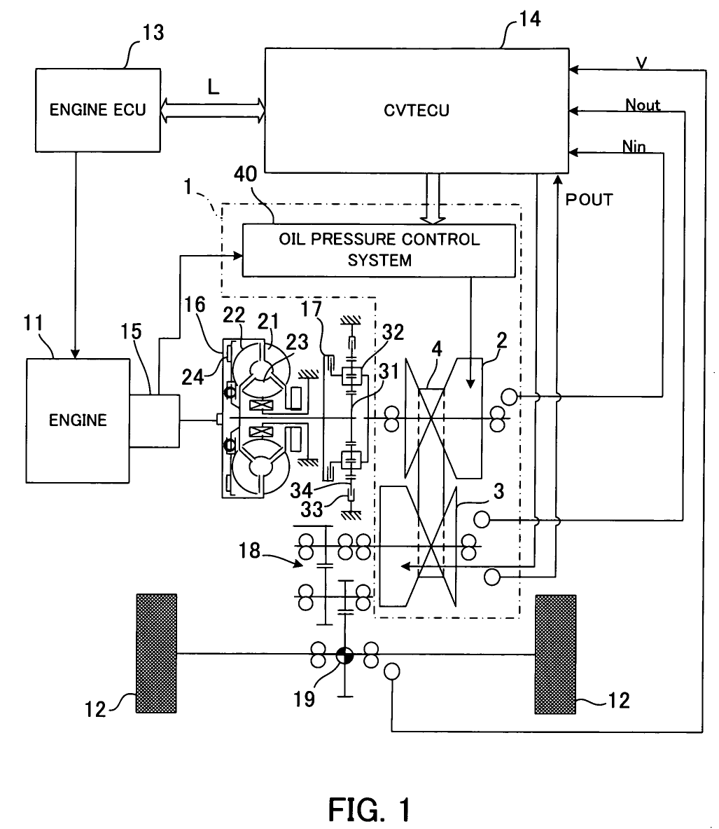

In the present embodiment, a method of controlling a continuously variable transmission according to the present invention is applied to a vehicle control system. FIG. 1 is a diagram showing a system configuration of the vehicle control system including a continuously variable transmission according to the present embodiment.

In the vehicle control system, a continuously variable transmission 1 of a belt type is disposed between an engine 11, which is a drive source of a vehicle, and drive wheels 12, and controlled objects are controlled by respective electronic control units (hereinafter simply referred to as “the ECUs”). More specifically, engine control is performed by an ECU 13 provided for the engine (hereinafter referred to as “the engine ECU 13”), and transmission control, described hereinafter, is performed by an ECU 14 provided for the continuously variable transmission 1 (hereinafter referred to as “the CVTECU 14”). To an output shaft of the engine 11 are connected an oil pump 15, a torque converter 16, a forward/backward travel-switching device 17, the continuously variable transmission 1, and a reduction gear 18, one after another, and an output of the reduction gear 18 is transmitted to the left and right drive wheels 12 via a differential 19.

The engine ECU 13 and the CVTECU 14 are independent electronic control units mainly constructed by arithmetic sections implemented by microcomputers, respectively. Each ECU is comprised of a CPU (Central Processing Unit) that performs various computations, a ROM (Read Only Memory) that stores control computation programs and data, a RAM (Random Access Memory) that stores numerical values and flags used in computation processes in predetermined areas thereof, an EEPROM (Electronically Erasable and Programmable Read Only Memory) which is a nonvolatile storage device that stores results of the computations and so forth, an A/D (Analog-to-Digital) converter for converting input analog signals to digital signals, an I/O interface via which various digital signals are input or output, a time-counting timer used in the computation processes, a bus line to which the above components are connected. Further, the ECUs contain communication control sections for performing mutual communication processing therebetween via a communication line L so as to enable data to be sent and received to and from each other.

The engine ECU 13 contains a signal input/output section that takes in output signals from sensors that detect conditions of the engine 11, and outputs drive signals to various actuators provided in the engine 11. More specifically, to the signal input/output section of the engine ECU 13 are connected not only various kinds of sensors and switches, such as an accelerator pedal opening sensor that detects a stepped-on amount of an accelerator pedal of the vehicle, an air flow meter that detects the amount of intake air, an intake air temperature sensor that detects the temperature of intake air, a throttle opening sensor that detects the opening degree of a throttle valve, an engine coolant temperature sensor that detects the temperature of an engine coolant, an engine speed sensor that detects engine speed, a vehicle speed sensor that detects the speed of the vehicle based on the rotation of a drive shaft of the vehicle, and an ignition switch, but also various kinds of actuators, such as injectors provided respectively for the cylinders of the engine 11, igniters that generates high voltage for ignition, a fuel pump that pumps fuel from a fuel tank to supply the same to the injectors, and a throttle drive motor that opens and closes the throttle valve disposed in an intake pipe of the engine 11. The engine ECU 13 carries out predetermined engine control processes in accordance with control programs stored in the ROM.

The CVTECU 14 contains a signal input/output section that takes in output signals from sensors that detect conditions of the continuously variable transmission 1, and outputs drive signals to various actuators provided in the continuously variable transmission 1. More specifically, as shown in FIG. 1, connected to the signal input/output section of the CVTECU 14 are not only various kinds of sensors and switches, such as an input shaft rotational speed sensor that detects a rotational speed Nin of an input shaft of the continuously variable transmission 1, an output shaft rotational speed sensor that detects a rotational speed Nout of an output shaft of the continuously variable transmission 1, the vehicle speed sensor that detects the speed V of the vehicle based on the rotation of the drive shaft of the vehicle, an oil temperature sensor that detects the temperature of hydraulic oil, a belt clamping pressure sensor that detects oil pressure (belt clamping pressure described hereinafter) within a secondary pulley, a stop lamp switch that detects a brake operation by the driver, and a shift position sensor that detects the current shift position, but also various kinds of actuators, such as a transmission solenoid that controls the speed change operation of the continuously variable transmission 1, a belt clamping pressure solenoid that controls the belt clamping force of the continuously variable transmission 1 for clamping a belt to suppress slippage of the belt, a line pressure control solenoid that controls line pressure, which is source pressure of oil pressure for use in the transmission (speed change) control, a lockup pressure solenoid that is used to handle the engaging force of a lockup clutch, described hereinafter, for engaging the input and output shafts of the torque converter 16 with each other. The CVTECU 14 performs a transmission control process, described hereinafter, according to a control program stored in the ROM.

The torque converter 16 is provided for smoothly transmitting the power of the engine 11 to an axle of the vehicle, and is comprised of a pump impeller 21 connected to an output shaft of the engine 11, a turbine liner 22 connected to an output shaft of the torque converter 16, a stator disposed between the pump impeller 21 and the turbine liner 22 for changing the flow of oil within the torque converter 16, and the lockup clutch 24 that engages the pump impeller 21 and the turbine liner 22 with each other depending on a predetermined condition.

The forward/backward travel-switching device 17 is formed by a planetary gear, and includes a sun gear 31 connected to the output shaft of the torque converter 16, a carrier 32 connected to the input shaft of the continuously variable transmission 1, and a ring gear connected to a brake 33.

The continuously variable transmission 1 is comprised of a primary pulley 2 connected to the input shaft disposed on a drive side, a secondary pulley 3 connected to the output shaft disposed on a driven side, and a V belt 4 stretched between the primary pulley 2 and the secondary pulley 3, and transmits torque transmitted from the input shaft to the output shaft. The continuously variable transmission 1 changes the width of a groove of the primary pulley 2 by control of oil pressure, and at the same time holds the belt clamping force of the secondary pulley 3 for clamping the V belt 4 by control of oil pressure, to change the belt-winding diameters of the respective pulleys around which the V belt 4 turns, to thereby continuously change the transmission ratio of the continuously variable transmission 1, which is the ratio between the rotational speed of the input shaft and that of the output shaft. The above oil pressure control for the primary pulley 2 and the secondary pulley 3 is carried out by an oil pressure control system 40, as will be described in detail hereinafter.

The reduction gear 18 is provided for causing the direction of rotation of the axle of the vehicle to coincide with the direction of rotation of the output shaft of the engine 11. More specifically, in the continuously variable transmission 1, the direction of rotation is inverted between the input shaft and the output shaft thereof, and the reduction gear 18 further inverts the inverted direction of rotation of the output shaft to cause the same to coincide with the direction of rotation of the input shaft.

The differential 19 transmits the output of the reduction gear 18 to axle shafts connected respectively to the left and right drive wheels 12, and absorbs the difference in the rotations of the left and right drive wheels 12 when the vehicle is traveling on a curved road, thereby realizing smooth traveling of the vehicle.

Next, a detailed description will be given of the arrangement and operation of the above-described continuously variable transmission 1.

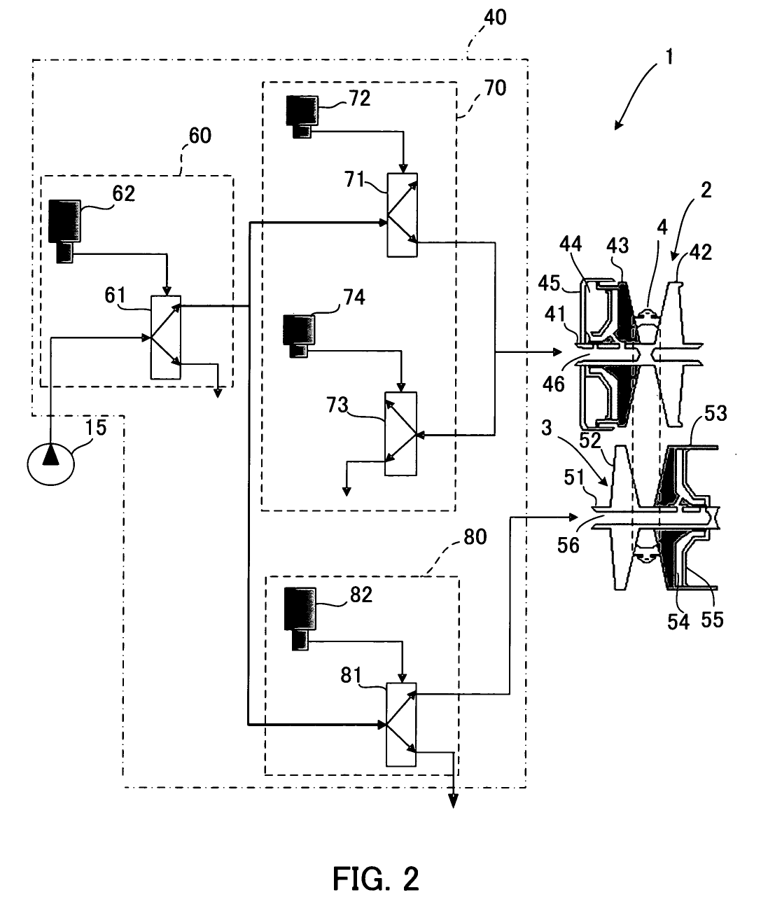

FIG. 2 is an explanatory view schematically showing the arrangement of the continuously variable transmission.

The continuously variable transmission 1 is comprised of a transmission mechanism comprised of the primary pulley 2, the secondary pulley 3, and the V belt 4, and the oil pressure control system 40 that hydraulically controls the operation of the transmission mechanism. The oil pressure control system 40 performs the oil pressure control based on a control command signal delivered from the CVTECU 14.

The primary pulley 2 includes a fixed wheel 42 integrally formed with the input shaft 41 of the continuously variable transmission 1, and a movable wheel 43 disposed in opposed relation to the fixed wheel 42. A tapered groove for clamping the V belt 4 is formed between the fixed wheel 42 and the movable wheel 43. Further, a casing 45 defining a primary chamber 44 variable in volume between the same and the movable wheel 43 is integrally formed with the input shaft 41 on a side of the movable wheel 43 remote from the V belt 4. Formed within the input shaft 41 is an oil passage 46 for supplying and discharging hydraulic oil to and from the primary chamber 44 under control of the oil pressure control system 40. By controlling the amount of hydraulic oil in the primary chamber 44, the movable wheel 43 is caused to move toward and away from the fixed wheel 42, thereby changing the belt-winding diameter of the V belt 4.

The secondary pulley 3 includes a fixed wheel 52 integrally formed with the output shaft 51 of the continuously variable transmission 1, and a movable wheel 53 disposed in opposed relation to the fixed wheel 52. A tapered groove for clamping the V belt 4 is formed between the fixed wheel 52 and the movable wheel 53. Further, a chamber wall 55 defining a secondary chamber 54 variable in volume between the same and the movable wheel 53 is integrally formed with the output shaft 51 on a side of the movable wheel 53 remote from the V belt 4. Formed within the output shaft 51 is an oil passage 56 for supplying and discharging hydraulic oil to and from the secondary chamber 54 under control of the oil pressure control system 40. By controlling the amount of hydraulic oil in the secondary chamber 54, the movable wheel 53 is caused to move toward and away from the fixed wheel 52, whereby the belt clamping force for clamping the V belt 4 is held.

In short, the belt-winding diameters of the primary pulley 2 and the secondary pulley 3 for winding the V belt 4 are changed under the control of the oil pressure control system 40, to thereby continuously change the transmission ratio between the input shaft and the output shaft. In doing this, the belt clamping force of the secondary pulley 3 prevents or suppresses the slippage of the V belt 4 with respect to each pulley.

The oil pressure control system 40 is comprised of a line pressure control device 60 that generates line pressure by using hydraulic oil pumped from an oil pressure source by the oil pump 15, a primary oil amount control device 70 that controls the amount of oil in the primary chamber 44 of the primary pulley 2 by using the line pressure, and a belt clamping pressure control device 80 that generates belt clamping pressure to be supplied to the secondary pulley 3 by reducing the line pressure.

The line pressure control device 60 includes a line pressure control valve 61 that operates to generate line pressure serving as source pressure, and a line pressure control solenoid 62 (corresponding to “a line pressure control actuator”) that controls the operation of the line pressure control valve 61. The line pressure control solenoid 62 drives the line pressure control valve 61 such that the line pressure has a magnitude dependent on the value of electric current supplied based on a command from the CVTECU 14.

The primary oil amount control device 70 controls the flow rate of hydraulic oil flowing into and out from the primary chamber 44 of the primary pulley 2 by using the line pressure generated by the line pressure control device 60. The primary oil amount control device 70 includes an up-shift valve 71 that operates to increase the flow rate of hydraulic oil, an up-shift solenoid 72 that drivingly controls the up-shift valve 71, a down-shift valve 73 that operates to decrease the flow rate of hydraulic oil, and a down-shift solenoid 74 that drivingly controls the down-shift valve 73.

The up-shift solenoid 72 and the down-shift solenoid 74 are operated by duty control in which the energization of each of the solenoids 72 and 74 is turned on or off based on a command from the CVTECU 14. The up-shift solenoid 72 drives the up-shift valve 71 such that the up-shift valve 71 can obtain an opening area dependent on a duty ratio of electric supplied thereto, and adjusts the amount of hydraulic oil supplied at line pressure to the primary chamber 44. On the other hand, the down-shift solenoid 74 drives the down-shift valve 73 such that the down-shift valve 73 can obtain an opening area dependent on a duty ratio of electric current supplied thereto based on a command from the CVTECU 14, and adjusts the amount of hydraulic oil discharged from the primary chamber 44.

More specifically, when the transmission control is to be stopped, the energization of the up-shift solenoid 72 and the down-shift solenoid 74 is stopped. When down-shift transmission control is carried out, the down-shift solenoid 74 is energized at a duty ratio based on the command from the CVTECU 14 in a state where the energization of the up-shift solenoid 72 is stopped. When up-shift transmission control is to be carried out, the up-shift solenoid 72 is energized at a duty ratio based on the command from the CVTECU 14 in a state where the energization of the down-shift solenoid 74 is stopped.

The belt clamping pressure control device 80 includes a belt clamping pressure control valve 81 that reduces the line pressure generated by the line pressure control device 60, and a belt clamping pressure control solenoid 82 (corresponding to “a belt clamping pressure control actuator”) for drivingly controls the belt clamping pressure control valve 81. The belt clamping pressure control solenoid 82 actuates the belt clamping pressure control valve 81 such that the belt clamping pressure has a magnitude dependent on the value of electric current supplied based on the command from the CVTECU 14.

The CVTECU 14 performs feedback control using the difference between a target transmission ratio, which is a target value of transmission ratio, and an actual transmission ratio, which is the current transmission ratio. More specifically, PID control is carried out which includes proportional control for causing the actual transmission ratio to progressively approach the target transmission ratio by setting a control amount to a magnitude proportional to the difference between the target transmission ratio and the actual transmission ratio, integral control for reducing a steady-state deviation that cannot be eliminated by the proportional control alone, and differential control for causing the actual transmission ratio to quickly approach the target transmission ratio by setting a time constant to a smaller value, whereby command values which should be outputted to the respective solenoids for the transmission control are calculated. In the oil pressure control system 40, the solenoids are driven based on the command values to thereby drivingly control the respective valves, whereby the amount of hydraulic oil to be supplied to and discharged from the primary chamber 44 and the pressure (belt clamping pressure) of hydraulic oil to be supplied to and discharged from the secondary chamber 54 are adjusted such that the target transmission ratio can be obtained.

Next, a description will be given of the method of controlling the continuously variable transmission according to the present embodiment.

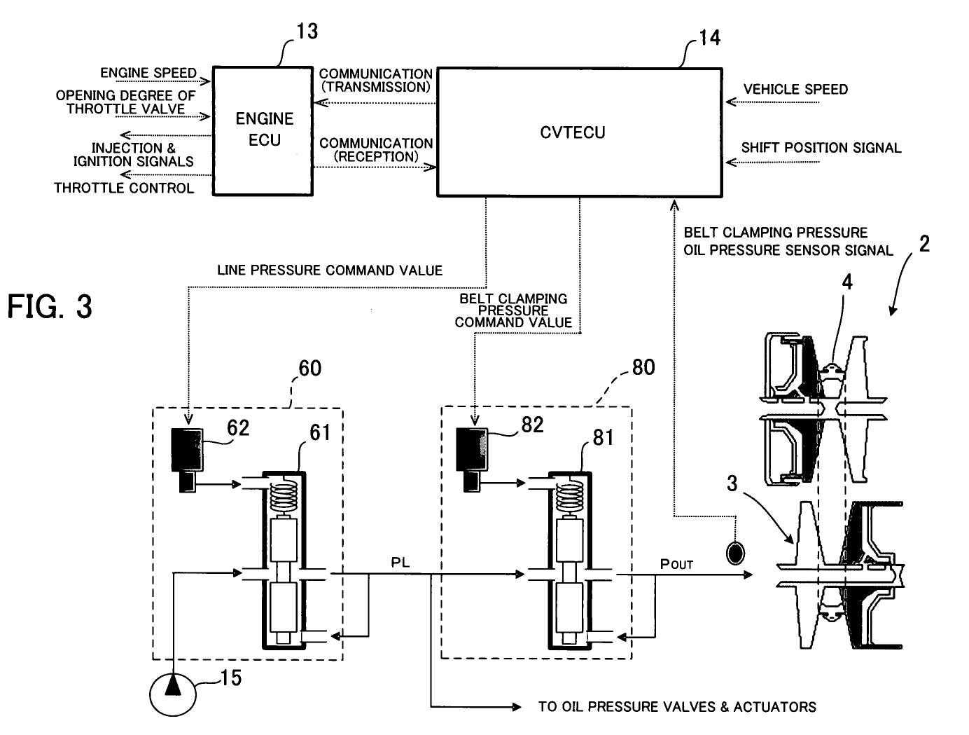

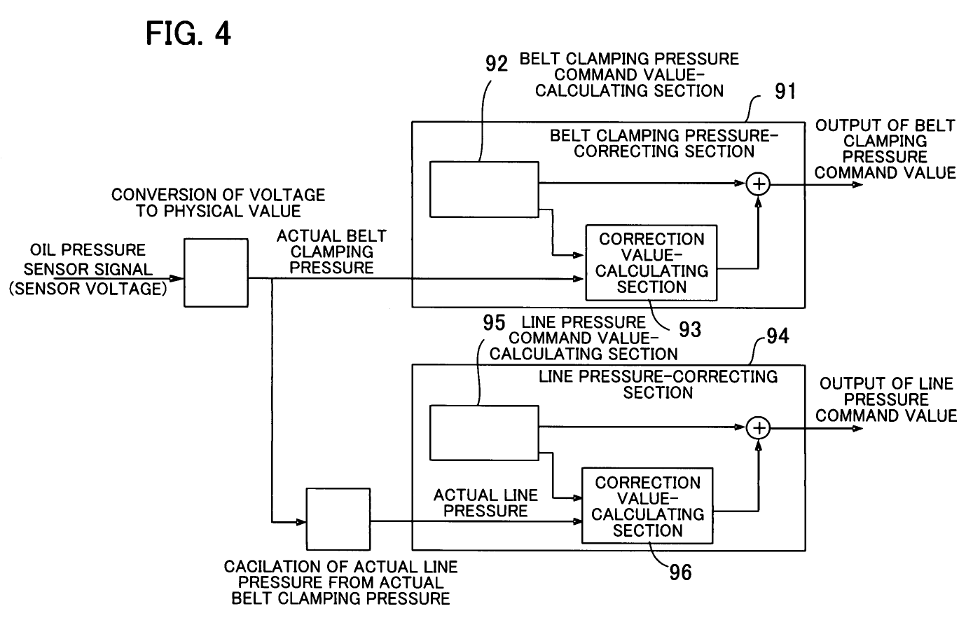

This oil pressure-learning method is provided for learning a belt clamping pressure command value outputted to the belt clamping pressure control solenoid 82 as a control command value of belt clamping pressure, and a line pressure command value outputted to the line pressure control solenoid 62 as a control command value of line pressure. FIG. 3 is an explanatory view schematically showing the arrangement of essential components of the continuously variable transmission to which is applied the oil pressure-learning method. Further, FIG. 4 is a functional block diagram illustrating an example of an oil pressure learning process executed by the CVTECU.

Referring to FIG. 3, in the continuously variable transmission 1, the line pressure control solenoid 62 for controlling the line pressure control valve 61 and the belt clamping pressure control solenoid 82 for controlling the belt clamping pressure control valve 81 are provided as oil pressure actuators independent of each other.

Here, the line pressure command value and the belt clamping pressure command value are corrected in advance in view of the cases where variations in size and shape of structures forming the oil pressure control system 40, variations in the electric characteristics of the oil pressure actuator, and so forth make it impossible to obtain line pressure and belt clamping pressure as intended by the target values when using the line pressure command value and the belt clamping pressure command value set as default values in designing the oil pressure control system 40. More specifically, in the oil pressure-learning method, the belt clamping pressure command value, which is outputted to the belt clamping pressure control solenoid 82 as a control command value of belt clamping pressure POUT, and the line pressure command value, which is outputted to the line pressure control solenoid 62 as a control command value of line pressure PL, are corrected in advance, and the corrections are learned and reflected on control executed thereafter.

The CVTECU 14 receives an oil pressure sensor signal indicative of the belt clamping pressure, delivered from the above-described belt clamping pressure sensor, performs learning correction, described hereinafter, of the line pressure command value and the belt clamping pressure command value, and outputs the corrected line pressure command value and belt clamping pressure command value to the line pressure control solenoid 62 and the belt clamping pressure control solenoid 82, respectively.

As shown in FIG. 4, the CVTECU 14 converts sensor voltage as the oil pressure sensor signal delivered from the belt clamping pressure sensor to actual belt clamping pressure as a physical value indicative of current belt clamping pressure using a lookup map, and corrects a current belt clamping pressure command value in a belt clamping pressure-correcting section 91. More specifically, a belt clamping pressure command value-calculating section 92 calculates a belt clamping pressure command value currently delivered by the CVTECU 14, and a correction value-calculating section 93 calculates a required correction value based on the difference between the current belt clamping pressure command value and the actual belt clamping pressure. Then, the calculated correction value is added to the current belt clamping pressure command value to thereby determine a new belt clamping pressure command value, and delivers the new belt clamping pressure command value to the belt clamping pressure control solenoid 82 in the following control. For example, when the actual belt clamping pressure is 2.8 Mpa while the current belt clamping pressure command value is 3.0 Mpa, 3.2 Mpa obtained by adding the difference 0.2 Mpa to the current belt clamping pressure command value is set to a new belt clamping pressure command value. Thus, in the following oil pressure control, when 3.0 Mpa is desired to be obtained, the belt clamping pressure command value is automatically changed to 3.2 Mpa and outputted, whereby an actual belt clamping pressure of 3.0 Mpa is accurately obtained.

Further, after converting the sensor voltage delivered from the belt clamping pressure sensor to the actual belt clamping pressure as a physical value indicative of the current belt clamping pressure, as described above, the CVTECU 14 calculates actual line pressure as current line pressure based on the actual belt clamping pressure. More specifically, here, the CVTECU 14 maximizes the opening degree of the belt clamping pressure control valve 81 to prevent the belt clamping pressure control valve 81 from reducing the actual line pressure, and thereby cause the actual belt clamping pressure to be substantially equal to the actual line pressure. Then, the CVTECU 14 measures the actual belt clamping pressure and regards that the actual line pressure has been calculated by the measurement. However, even if the line pressure command value is set to a value larger than a maximum value which can be set to the actual belt clamping pressure, the actual belt clamping pressure cannot assume a value larger than the maximum value, which prevents the actual line pressure and the actual belt clamping pressure from becoming equal to each other. This makes it impossible to determine the actual line pressure. Therefore, the learning correction of the belt clamping pressure command value is performed in a range up to the maximum value which can be set to the actual belt clamping pressure.

In the CVTECU 14, a line pressure-correcting section 94 corrects the line pressure command value. More specifically, a line pressure command value-calculating section 95 calculates a line pressure command value currently delivered by the CVTECU 14, and a correction value-calculating section 96 calculates a required correction value based on the difference between the current line pressure command value and the actual line pressure. Then, the calculated correction value is added to the current line pressure command value to thereby determine a new line pressure command value, and delivers the new line pressure command value to the line pressure control solenoid 62 in the following control. For example, when the actual line pressure is 5.2 Mpa while the current line pressure command value is 5.0 Mpa, 4.8 Mpa obtained by adding the difference −0.2 Mpa to the current line pressure command value is set to a new line pressure command value. Thus, in the following oil pressure control process, when 5.0 Mpa is desired to be obtained, the line pressure command value is automatically changed to 4.8 Mpa and outputted, whereby a line pressure of 5.0 Mpa is accurately obtained.

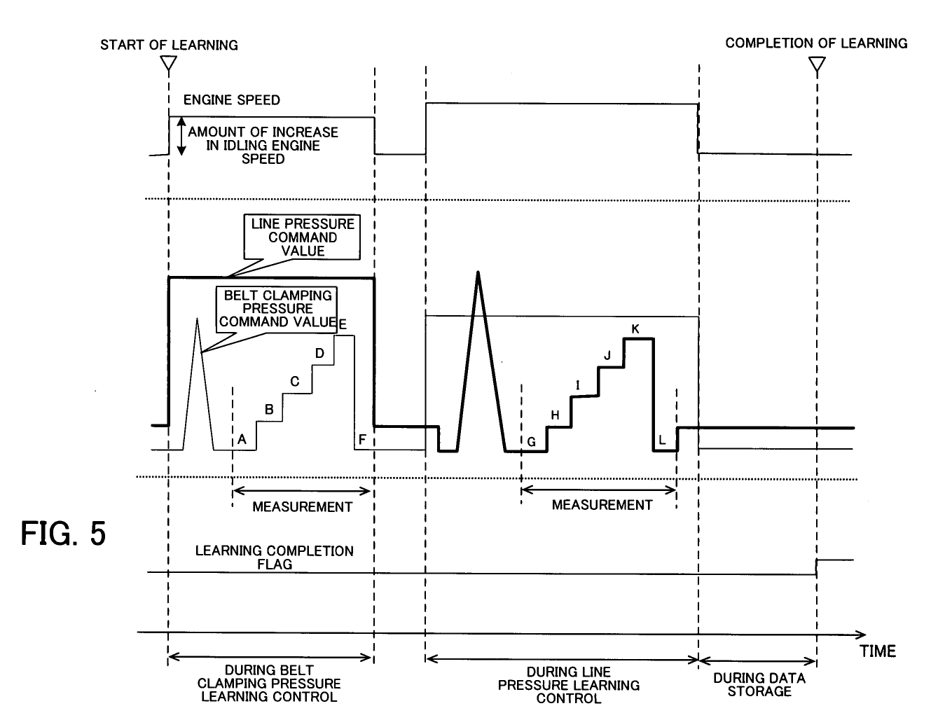

Next, a description will be given of an example of the method of controlling the continuously variable transmission. FIG. 5 is a timing diagram showing an example of the oil pressure learning process executed by the CVTECU. In the figure, the horizontal axis represents time elapsed, and the vertical axis represents the engine speed, the control command values, and the state of a learning completion flag in the mentioned order from above.

In the oil pressure learning process, first, the learning correction of the belt clamping pressure command value is executed, and after termination thereof, the learning correction of the line pressure command value is executed in succession.

In a learning correction process of the belt clamping pressure command value, to secure line pressure, which is source pressure of the belt clamping pressure, the line pressure command value is fixed to maximum pressure simultaneously when the learning process is started, to thereby fully open the line pressure control valve 61. Further, to secure oil pressure generated by the oil pump 15 that pumps hydraulic oil from the oil pressure source, idling engine speed of the engine 11 for driving the oil pump 15 is increased in advance by a required amount.

Then, before the start of the learning correction of the belt clamping pressure command value, the belt clamping pressure command value is continuously increased and decreased to once make the belt clamping pressure control valve 81 fully open and then set the same to an initial state (state of stage A), whereby the belt clamping pressure control valve 81 is placed in a state free from adverse influence of oil pressure hysteresis. After that, the belt clamping pressure command value is stepwise increased from a low-pressure command value A to command values B, C, D, and E.

Now, a description will be given of the above-mentioned oil pressure hysteresis.

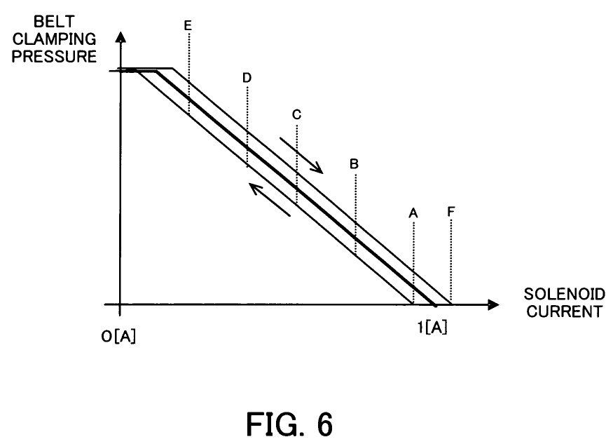

FIG. 6 is an explanatory view showing an example of influence of the oil pressure hysteresis in the oil pressure control using a solenoid-actuated control valve. In FIG. 6, the horizontal axis represents the value of electric current supplied to the solenoid, and the vertical axis represents oil pressure.

More specifically, in an oil pressure valve, such as the belt clamping pressure control valve 81, the characteristics of oil pressure thereof are sometimes different between a pressure-raising side and a pressure-lowering side. This is due to biting of a foreign matter in the oil pressure valve and a manufacturing error of the oil pressure valve. To eliminate the inconvenience, oil pressure is raised and lowered between the lowest pressure and the highest pressure, as described above, to thereby eliminate the foreign matter as a factor causing the oil pressure hysteresis.

Then, the actual belt clamping pressure is measured in each of the above-mentioned stages, and the oil pressure learning process is carried out using the difference between the actual belt clamping pressure and the present belt clamping pressure command value.

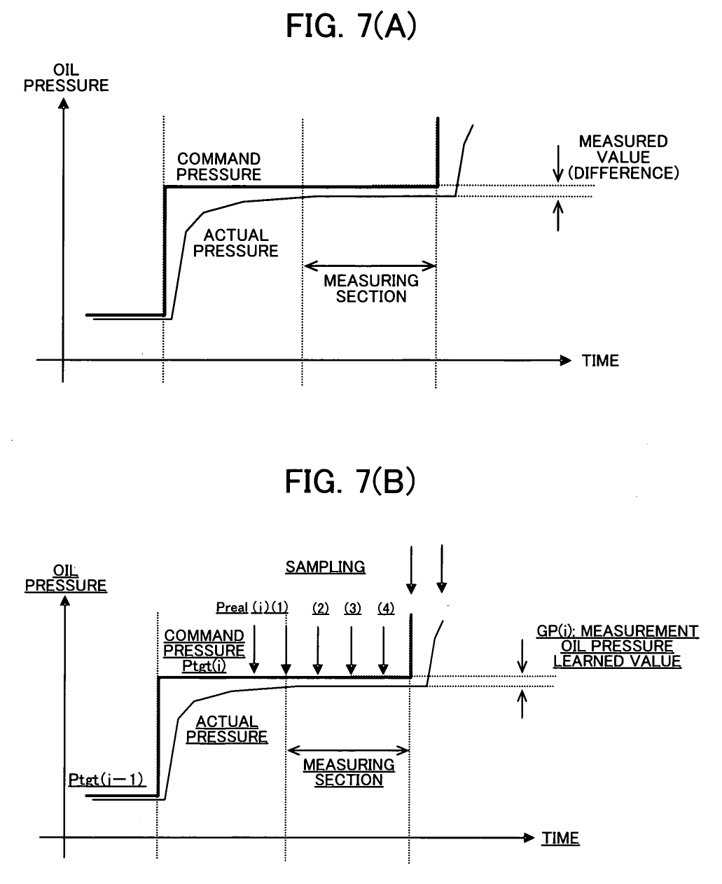

FIGS. 7(A) and 7(B) are explanatory views showing the timings for measuring the actual belt clamping pressure in each stage of the learning correction. In both of FIGS. 7(A) and 7(B), the horizontal axis represents time, and the vertical axis represents oil pressure (belt clamping pressure).

Even if command pressure (belt clamping pressure command value) is outputted in a stepwise fashion as shown in FIG. 7 (A), there exists response delay before actual pressure (actual belt clamping pressure) appears in response thereto. Therefore, when the actual belt clamping pressure is measured during the time of the response delay, the difference between the actual belt clamping pressure and the belt clamping pressure command value is calculated as a value larger than an actual value. To solve the problem, the actual belt clamping pressure is measured not during the delay time but in a section (measuring time period illustrated in FIG. 7(A)) where follow-up of the actual pressure has been completed. The delay time is calculated and reflected in advance on timing for sampling the actual belt clamping pressure.

Further, referring to FIG. 7(B), in the respective stages of the learning correction process, correction values are calculated a plurality of times (four times in the present embodiment), and an average value thereof is used as a correction value in calculation of the belt clamping pressure command value. More specifically, when a plurality of belt clamping pressure command values are represented by Ptgt(i) (i corresponds to stages A to E in FIG. 5), and a plurality of measured values of actual belt clamping pressure by Preal(i), the present correction value GP(i) is expressed by the following equation (1):
GP(i)=Ptgt(i)−{Preal(i)(1)+Preal(i)(2)+Preal(i)(3)+Preal(i)(4)}/4 (1)

The correction values are only required to be set once in principle unless the correction values have to be set a plurality of times under special circumstances, such as replacement or aging of the control device, and therefore the correction values are stored in a nonvolatile memory, such as an EEPROM or a standby RAM (memory capable of holding data by a battery even when an ignition switch is turned off), for regular use.

It should be noted that the correction values GP(A) to GP(E) calculated by the equation (1) are required to be stored as group data. Therefore, when the learning process is stopped in the course of storage of the group data by a certain cause, such as turning-off of the ignition switch, and it is impossible to restore the data, the learning process is performed again for the whole area of group data from the start thereof.

Referring again to FIG. 5, after maximum command pressure E in the above correction process is instructed, the oil pressure is lowered, and actual belt clamping pressure corresponding to the same belt clamping pressure command value outputted at the start (stage A) of the learning process is measured again (stage F), whereby it is checked whether or not the belt clamping pressure control valve 81 is faulty, based on whether or not oil pressure hysteresis occurs, and the magnitude of the hysteresis. When the belt clamping pressure control valve 81 is faulty, an action, such as replacement of the belt clamping pressure control valve 81, is taken. Then, after the learning correction of the belt clamping pressure command values has been completed, the line pressure command value is set to an initial value thereof, and the idling engine speed is reduced.

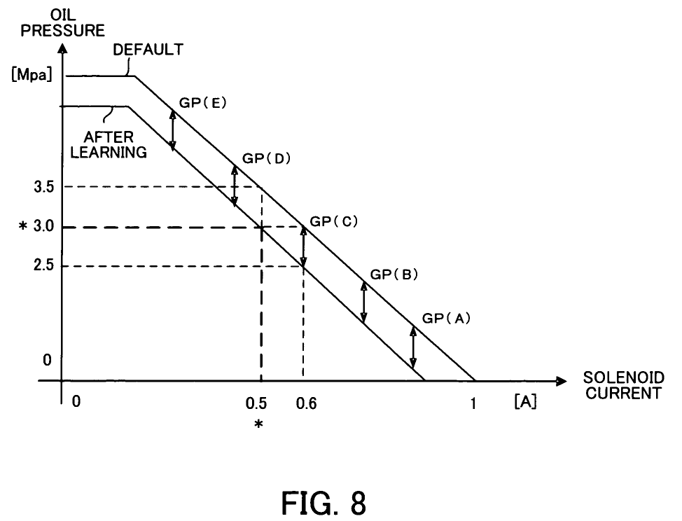

FIG. 8 is a conceptual diagram showing results of the learning correction, which illustrates the output characteristics of the oil pressure actuator. In FIG. 8, the horizontal axis represents the value of electric current which is supplied to the solenoid based on the belt clamping pressure command value, and the vertical axis represents belt clamping pressure generated according to the value of electric current. Further, “DEFAULT” indicates oil pressure characteristics before the learning correction, and “AFTER LEARNING” indicates oil pressure characteristics after the learning correction.

According to FIG. 8, if obtaining belt clamping pressure of 3.0 Mpa was instructed before the learning correction, for example, it means that an electric current value of 0.6 A was to be set to the solenoid due to default characteristics. However, when electric current of 0.6 A was caused to flow through the solenoid, FIG. 8 shows that only 2.5 Mpa of belt clamping pressure could be obtained actually.

According to the above-described learning correction, 0.5 Mpa, which is the present difference pressure between the instructed belt clamping pressure and the belt clamping pressure actually obtained, is calculated e.g. as a correction value GP(C), and this GP(C)=0.5 Mpa is added to the next belt clamping pressure command value. More specifically, to obtain belt clamping pressure of 3.0 Mpa, 3.5 Mpa is set as a new belt clamping pressure command value. This causes an electric current value of 0.5 A to be set to the solenoid, thereby making it possible to obtain an actual belt clamping pressure of 3.0 Mpa.

Referring again to FIG. 5, in a learning correction process of the line pressure command value, following the learning correction process of the belt clamping pressure command value, the belt clamping pressure command value is fixed to maximum pressure at the start of the learning process so as to fully open the belt clamping pressure control valve 81. Further, at this time, to secure oil pressure generated by the oil pump 15 that pumps hydraulic oil from the oil pressure source, the idling engine speed of the engine 11 for driving the oil pump 15 is increased by a required amount.

Then, before the start of the learning correction of the line pressure command value, the line pressure command value is continuously increased and decreased to once make the line pressure control valve 61 fully open and then return the same to an initial state (state of stage G), whereby the line pressure control valve 61 is placed in a state free from adverse influence of oil pressure hysteresis. The reason for this is the same as in the case of the learning correction of the belt clamping pressure command value. Then, the belt clamping pressure command value is stepwise increased from a low-pressure command value G to command values H, I, J, and K, and the above-described oil pressure learning process is carried out using the difference between the actual line pressure and the present line pressure command value. In this case, however, since the actual belt clamping pressure is determined as the actual line pressure as described above, maximum command pressure K is set to a value that does not exceed maximum pressure of the belt clamping pressure.

Then, after maximum command pressure K in the above correction process is instructed, the oil pressure is lowered, and line pressure corresponding to the same line pressure command value outputted at the start (stage G) of the learning process of the line pressure command value is measured again (stage L), whereby it is checked whether or not the line pressure control valve 61 is faulty, based on whether or not oil pressure hysteresis occurs and the magnitude of the hysteresis. When the line pressure control valve 61 is faulty, an action, such as replacement of the line pressure control valve 61 is taken, for example. Then, after the learning correction of the line pressure command values has been completed, the belt clamping pressure command value is set to an initial value thereof, and the idling engine speed is reduced.

It should be noted that details of the learning correction process of the line pressure command value are the same as those of the learning correction process of the belt clamping pressure command value shown in FIGS. 6 to 8, and hence detailed description thereof is omitted.

After completion of the above-described oil pressure learning process, “a learning completion flag” indicative of completion of the oil pressure learning process is set in the RAM. Therefore, by checking whether or not the learning completion flag exists, it is possible to know whether or not learning correction has already been performed.

It should be noted that here, although the learning correction of the line pressure command value is executed after execution of the learning correction of the belt clamping pressure command value, the learning correction of the line pressure command value may be executed before execution of the learning correction of the belt clamping pressure command value.

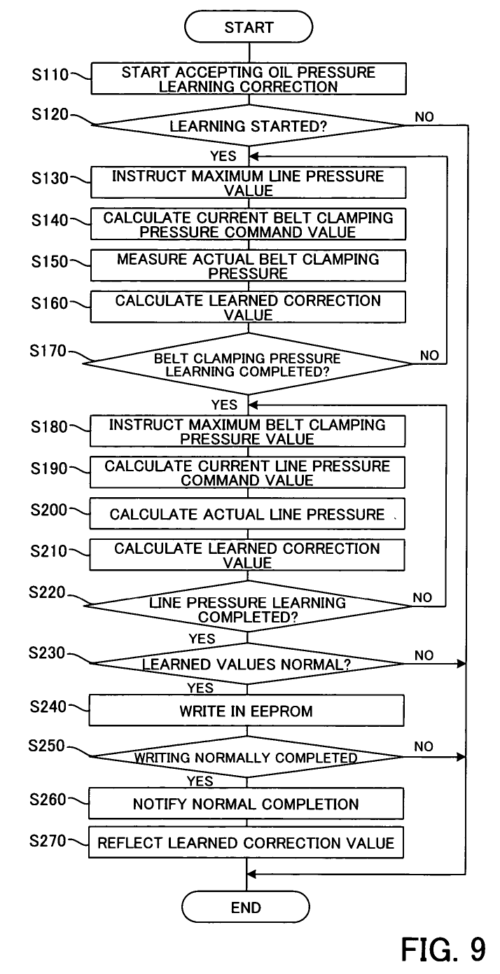

Next, a description will be given of the flow of the oil pressure learning process for control of the continuously variable transmission. FIG. 9 is a flowchart showing the flow of the oil pressure learning process carried out by the CVTECU. Hereafter, the flow of this process will be described using step numbers (hereinafter denoted using “S”).

First, a state in which a start command for starting oil pressure learning correction can be accepted is established in advance by an external input from a user or an operator (S110). Then, it is determined whether or not the start command has been inputted (S120). If the start command has not been inputted (S120: NO), the present process is immediately terminated.

On the other hand, if it is determined that the start command for starting the oil pressure learning correction has been inputted (S120: YES), the aforementioned learning correction process of the belt clamping pressure command value is carried out.

More specifically, first, a line pressure command value for setting the line pressure to its maximum value is delivered to the line pressure control solenoid 62 (S130). Then, a current belt clamping pressure command value is calculated (S140) and actual belt clamping pressure is measured (S150). Further, a correction value is calculated based on the difference between the current belt clamping pressure command value and the actual belt clamping pressure (S160). The calculated correction value is stored in a predetermined area in the RAM. The steps S130 to S160 are executed in each of the stages of the leaning correction of the belt clamping pressure command value.

Further, it is determined whether or not the leaning correction of the belt clamping pressure command value has been completed for all the stages (S170), and if it is determined that the leaning correction has been completed for all the stages (S170: YES), the program proceeds to the learning correction of the line pressure command value.

More specifically, first, a belt clamping pressure command value for setting the belt clamping pressure to its maximum value is delivered to the belt clamping pressure control solenoid 82 (S180). Then, a current line pressure command value is calculated (S190), and actual line pressure is measured (S200). Further, a correction value is calculated based on the difference between the current line pressure command value and the actual line pressure (S210). The calculated correction value is stored in a predetermined area in the RAM. The steps S180 to S210 are executed in each of the stages of the leaning correction of the line pressure command value.

Further, it is determined whether or not the leaning correction of the line pressure command value has been completed for all the stages (S220), and if it is determined that the leaning correction has been completed for all the stages (S220: YES), the process proceeds to the next step (S230), wherein it is determined whether or not there is any abnormality in the learned correction values.

The above determination of normality of the learned correction values is made by setting criteria defined by conditions which cannot be satisfied by normal computations, such as the learned correction value being varied to increase and decrease from one stage to another, exhibiting no linearity in the changes, and the learned correction value assuming a normally impossible value, in advance, and determining whether the criteria are satisfied. If it is determined that there is abnormality in the learned correction values (S230: NO), the present process is terminated. In this case, the leaning correction may be carried out again from the start.

If it is determined in S230 that there is no abnormality in the learned correction values (S230: YES), all the correction values stored in the RAM are written as group data in the nonvolatile memory, such as the EEPROM (S240). Then, it is determined whether or not the writing of the correction values has been normally terminated (S250). If it is determined that the writing of the correction values could not be normally terminated (S250: NO), the present process is immediately terminated.

If it is determined in S250 that the writing of the correction values has been normally terminated (S250: YES), a notification of normal completion of the process is displayed on a predetermined display device (S260). It should be noted that the notification may be performed by using a lamp or a buzzer of the vehicle.

Then, the learned correction value calculated as above is reflected on the control command values used thereafter (S270), followed by terminating the present process.

As described hereinabove, the oil pressure learning method according to the present embodiment is applied to the oil pressure control system 40 provided with the line pressure control solenoid 62 for controlling the line pressure control valve 61, and the belt clamping pressure control solenoid 82 for controlling the belt clamping pressure control valve 81. Further, the belt clamping pressure command value to be outputted to the belt clamping pressure control solenoid 82 as a control command value of the belt clamping pressure, and the line pressure command value to be outputted to the line pressure control solenoid 62 as a control command value of the line pressure are learned in advance. This enables the oil pressure control system 40 to control both the line pressure and the belt clamping pressure with accuracy.

It should be noted that although not described in the above-described embodiment, when the ignition switch is turned off during storage of the correction values e.g. in the EEPROM, a main relay of the CVTECU 14 may be held such that the power is supplied until the storage of the correction values is completed.

Further, when supply of the power from the battery is cut off in the course of storage of the group data e.g. in the EEPROM, interrupting the storage, predetermined initial data may be written in the EEPROM such that the EEPROM is returned to a state not subjected to the learning correction.

Further, when the battery is opened in the case of storing the group data of the correction values of the belt clamping pressure command value and the group data of the correction values of the line pressure command value, e.g. in the EEPROM, causing interruption of the storing process, if storage of one of the group data has been completed, predetermined initial data may be written only for the group data whose storing process is interrupted but the other group data may be held as they are.

Furthermore, the above-described reflection of the learned correction value on control command values used thereafter may be performed in timing in which the learning correction process is terminated, and after once turning off the ignition switch, and the ignition switch is turned on.

Further, it may be determined that normal calculation cannot be performed, to thereby terminate the learning correction process, when a measured value by the belt clamping pressure sensor is changed by an amount larger than a predetermined amount of change during a predetermined time period over which the actual belt clamping pressure is being measured in the above-described learning correction process, when a value measured by the belt clamping pressure sensor is fixed without becoming higher than a predetermined value, when any of the oil pressure actuators fails due to a disconnection or a short circuit, when the difference between each command value and the measured value associated therewith becomes larger than a predetermined value, when the idling engine speed of the engine 11 is not increased due to a disconnection or a short circuit, or when oil pressure hysteresis not smaller than a predetermined value is detected.

Further, when the vehicle is caused to travel in a state in which the aforementioned learning correction has not been carried out, the line pressure and the belt clamping pressure cannot be controlled as instructed by commands from an electronic control unit, and there can occur slippage of the belt in the worst case. On the other hand, to avoid the above worst case, if values of the line pressure and the belt clamping pressure increased from the originally required oil pressures are set to command values, efficiency is degraded, resulting in the degraded fuel economy.

To solve the above problems, the learning correction of the belt clamping pressure command value and that of the line pressure command value may be performed automatically and continuously during a predetermined time period set in advance over which the problems do not occur. For example, it is necessary to complete the learning control before the vehicle is supplied to the market and travels, and when the continuously variable transmission 1 or the CVTECU 14 has been replaced, the correction values learned previously sometimes becomes not optimum. Therefore, the learning correction may be performed during a time period before factory shipping of the vehicle, or during a time period before the vehicle is delivered to the user after replacement of the CVTECU 14 or the continuously variable transmission 1 at a service center e.g. of a dealer. It should be noted that learning correction at the time of factory shipping of the vehicle is carried out during control in a learning mode.

Further, when learning correction is performed during driving of the vehicle, not to impart any sense of discomfort to the driver, the amount of an increase in the idling engine speed during the driving may be made smaller than the amount of an increase in the idling engine speed during learning in the learning mode.

Further, correction values learned at an initial stage before supply of the vehicle to the market sometime become not optimum due to aging of the vehicle or the like after the supply of the vehicle to the market. For example, when the characteristics of the control valves and control actuators have changed e.g. due to the aging of the vehicle, correction values learned at the initial stage are no longer optimum.

In this case, it is contemplated to measure the lapse of time measured e.g. by a timer of the CVTECU 14 and carry out learning correction in certain timing. To grasp the aging of the vehicle, however, it is necessary to measure the lapse of time over several months or years. This requires provision of a large-capacity storage device so as to measure the lapse of time with a computer integrated in the CVTECU 14. Further, the state of aging of the vehicle not only depends on the lapse of time but also on the frequency of use of the vehicle.

To cope with the above problems, by setting a parameter for grasping the aging of the vehicle to the travel distance of the vehicle and estimating the travel distance, at least one of the learning correction of the belt clamping pressure command value and that of the line pressure command value may be performed when the vehicle has traveled beyond a predetermined travel distance. The travel distance can be calculated by integrating vehicle speed measured e.g. by a wheel speed sensor provided in the vehicle with respect to time. When the travel distance has reached a determined distance, such as 1000 km, the above learning control may be executed.

According to the method of controlling the continuously variable transmission, and the oil pressure learning apparatus, of the present invention, line pressure and belt clamping pressure are controlled separately, and respective oil pressure command values of the line pressure and the belt clamping pressure are corrected, and reflected on the following control. Therefore, it is possible to accurately control both the line pressure and the belt clamping pressure.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A method of controlling a continuously variable transmission that generates belt clamping pressure supplied to a secondary pulley from line pressure generated by controlling oil pressure of an oil pressure source, comprising:
a belt clamping pressure-learning step of performing learning correction of a belt clamping pressure command value based on the belt clamping pressure command value and an actual belt clamping pressure value; and
a line pressure-learning step of performing learning correction of a line pressure command value based on the line pressure command value and an actual line pressure value.

2. The method according to claim 1, wherein said belt clamping pressure-learning step is carried out in a state in which a control amount of the line pressure is held constant, and
wherein said line pressure-learning step is carried out in a state in which a control amount of the belt clamping pressure is held constant.

3. The method according to claim 1, wherein when the learning correction of the line pressure command value is executed, the belt clamping pressure command value is set to be larger than the line pressure command value during the learning correction.

4. The method according to claim 1, wherein when the learning correction of the line pressure command value is executed, the belt clamping pressure command value is set to be larger than a maximum value of the line pressure command value.

5. The method according to claim 1, wherein when the learning correction of the line pressure command value is executed, the belt clamping pressure command value is set such that a valve for generating the belt clamping pressure is made fully open.

6. The method according to claim 1, wherein when the learning correction of the belt clamping pressure command value is executed, the line pressure command value is set to be larger than the belt clamping pressure command value.

7. The method according to claim 1, wherein when the learning correction of the belt clamping pressure command value is executed, the line pressure command value is set to be larger than a maximum value of the belt clamping pressure command value.

8. The method according to claim 6, wherein the line pressure command value is changed according to oil temperature.

9. The method according to claim 7, wherein the line pressure command value is changed according to oil temperature.

10. The method according to claim 1, wherein when the learning correction of the belt clamping pressure command value and the learning correction of the line pressure command value are executed, to secure oil pressure generated by an oil pump that pumps hydraulic oil from the oil pressure source, an idling rotational speed of an engine for driving the oil pump is increased.

11. The method according to claim 10, wherein an amount of increase in the idling rotational speed is made different between when the learning correction of the belt clamping pressure command value is executed and when the learning correction of the line pressure command value is executed.

12. The method according to claim 3, wherein when the learning correction of the line pressure command value is executed, the line pressure command value is set to be not larger than a value corresponding to a maximum oil pressure that can be set as the belt clamping pressure.

13. The method according to claim 1, wherein when a control mode is set to a learning mode through a predetermined operation, at least one of said line pressure-learning step and said belt clamping pressure-learning step is carried out.

14. The method according to claim 1, wherein a travel distance of a vehicle is estimated, and when the vehicle has traveled beyond a predetermined travel distance, at least one of the learning correction of the belt clamping pressure command value and the learning correction of the line pressure command value is executed.

15. The method according to claim 14, wherein when at least one of the learning correction of the belt clamping pressure command value and the learning correction of the line pressure command value is executed during driving of the vehicle, to hold oil pressure generated by an oil pump that pumps hydraulic oil from the oil pressure source, an idling rotational speed of an engine for driving the oil pump is made smaller than an idling rotational speed of the engine set when the learning correction is executed during non-driving of the vehicle.

16. The method according to claim 1, wherein at least two line pressure command values are set in the learning correction of the line pressure command value, and at least two belt clamping pressure command values are set in the learning correction of the belt clamping pressure command value, and the learning correction is stepwise executed for the line pressure command values and the belt clamping pressure command values.

17. The method according to claim 16, wherein when the actual belt clamping pressure is measured in the learning correction of the belt clamping pressure command value and the learning correction of the line pressure command value, adverse influence of oil pressure hysteresis on a valve that is used for generating the belt clamping pressure and a valve that is used for generating the line pressure is eliminated by continuously increasing and decreasing each command value before starting each measurement, and
wherein the actual belt clamping pressure is measured when each command value is stepwise increased from a low-pressure command value, and the command value is decreased after instructing maximum command pressure, to thereby measure the actual belt clamping pressure measured at the start of the measurement again.

18. The method according to claim 16, wherein when the command value is stepwise increased, oil pressure is instructed by holding each of command values at respective stages for a predetermined time period, and then the actual belt clamping pressure with respect to the oil pressure command value is measured during a time period from a time point at which a predetermined time period has elapsed after delivery of a pressure-raising command to a time point a next pressure-raising instruction is delivered.

19. The method according to claim 16, wherein a plurality of correction values calculated when the learning correction is stepwise executed for the line pressure command values and the belt clamping pressure command values are stored in a nonvolatile memory as respective group data, and
wherein when supply of power from a battery is cut off in the course of storage of the group data in the nonvolatile memory, causing interruption of the storage of the group data, if storage of one of the group data has been completed, predetermined initial data are written only for the group data whose storage is interrupted, and the other group data whose storage has been completed are held as they are.

20. The method according to claim 16, wherein a plurality of correction values calculated when the learning correction is stepwise executed for the line pressure command values and the belt clamping pressure command values are stored in a nonvolatile memory as respective group data, and
wherein the correction values are reflected on the line pressure command values and the belt clamping pressure command values in timing in which after termination of processing of the learning correction, an ignition switch of a vehicle is once turned off, and then the ignition switch is turned on again.

21. A control system for a continuously variable transmission, comprising:
a line pressure command value-calculating section that calculates a line pressure command value for controlling a valve that is used for generating line pressure from oil pressure of an oil pressure source;
a belt clamping pressure command value-calculating section that calculates a belt clamping pressure command value for controlling a valve that is used for generating belt clamping pressure supplied to a secondary pulley, from the line pressure;
a belt clamping pressure correction value-calculating section that performs learning correction of the belt clamping pressure command value based on the belt clamping pressure command value and an actual belt clamping pressure value; and
a line pressure correction value-calculating section that performs learning correction of the line pressure command value based on the line pressure command value and an actual line pressure value.

22. The control system according to claim 21, wherein when the line pressure correction value-calculating section executes the learning correction of the line pressure command value, the belt clamping pressure command value-calculating section sets the belt clamping pressure command value such that the belt clamping pressure command value becomes larger than the line pressure command value during the learning correction.

23. The control system according to claim 21, wherein when the line pressure correction value-calculating section executes the learning correction of the line pressure command value, the belt clamping pressure command value-calculating section sets the belt clamping pressure command value such that the belt clamping pressure command value becomes larger than a maximum value of the line pressure command value.
